(19) United States
(12) Patent Application Publication
(10) Pub. No.: US 2003/0131679 A1
(43) Pub. Date: Jul. 17, 2003

(54) Shift lever with counterbalance

(76) Inventors: Tom Balamucki, Laurinburg, NC (US); Beth I. Klimek, Maxton, NC (US)

Correspondence Address: CARLSON, GASKEY & OLDS, P.C., 400 WEST MAPLE ROAD, SUITE 350, BIRMINGHAM, MI, 48009, US

(21) Appl. No.: 10/051,821

(22) Filed: Jan. 17, 2002

(51) Int. Cl. B60K 20/00; G05G 1/04

(52) U.S. Cl. 74/473.29; 74/523; 74/473.3

(57) ABSTRACT

A transmission assembly comprises a transmission, a pivot, and a shift lever operatively connected to the pivot for manipulating the transmission. The shift lever has a first center of mass at a first location relative to the pivot. A counterbalance is connected to the shift lever and comprises a second center of mass at a second location from the pivot such that the shift lever and the counterbalance comprise a total center of mass located between the first location and the second location.

### BACKGROUND OF THE INVENTION

The invention relates to a vehicle shift lever having a counterbalance to aid in the prevention of shift lever “jump out” and improve transmission shifting.

Manufacturers of trucks use shift levers with multiple bends to position the shift lever within reach of the vehicle operator and to accommodate the limited space around the truck transmission. These shift levers are typically connected to a pivot about which the left lever moves to actuate the desired gears of the truck's transmission. Shift levers have become heavy and unbalanced, having an overall center of mass away from the pivot point rather than near this point. By accommodating the packaging constraints and the needs of the driver, existing shift levers may tend to be top heavy. The location of the center of mass creates the potential for undesirable moment on the shift lever. The center of mass accelerated by road vibrations caused by potholes and other road conditions may cause the shift lever to move in the direction of disengagement of the gears of the transmission. Consequently, during normal operation, these shift levers may “jump out” of the gear selected by the operator. Moreover, an unbalanced shift lever may be difficult to shift, requiring added effort to move the lever from one shift position to another. These results are undesirable.

A need therefore exists to retain the design features required by manufacturers while adjusting the center of mass to reduce the amount of torque experienced by the shift lever during vehicle operation.

### SUMMARY OF THE INVENTION

The present invention involves the use of a counterbalance to adjust the location of the center of mass of the entire shift lever assembly with respect to the shift lever's pivot point. In this way, incidental moment caused by road conditions is greatly reduced, thereby permitting the shift lever to stay in gear. Moreover, the improved balance of the shift lever results in easier shifting of the lever to the various shift positions of the vehicle.

Hence, the shift lever placed on a pivot is counterbalanced. The first mass of the shift lever creates a torque that is offset by the torque created by the second mass of the counterbalance. The benefits of the invention are accordingly realized and result in a shift lever with a center of mass closer to the pivot of the shift lever, thereby reducing the likelihood of “jump out” and reducing any drag on shifting.

One feature of the invention includes a transmission, a pivot, a shift lever connected to the pivot, and a counterbalance. The counterbalance is attached to the shift lever. The shift lever includes a first center of mass and the counterbalance includes a second center of mass such that the combination of the first mass and the second mass moves the total of the masses closer to the pivot point, thereby improving the balance of the shift lever.

The total center of mass may be moved closer to the pivot by the counterbalance along two different directions. The counterbalance may move the total center of mass along a vertical direction and a horizontal direction. The counterbalance may balance the shift lever along two axis transverse to each other.

Additionally, the counterbalance may include a counterbalance resiliently connected to the shift lever so as to reduce vibration of the lever during operation. A housing may support the pivot of the lever. The pivot may be in the housing while the counterbalance located outside of the housing.

Another feature of the invention may include a method of manufacturing a shift lever. The center of mass of a shift lever is determined. To move the center of mass, a portion of the shift lever is bent such that the center of mass is moved closer to the pivot. The shift lever is connected to the pivot. A plurality of bends may be made to adjust the location of the center of mass both horizontally and vertically.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 shows a schematic side view of the prior art shift lever, including pivot, shift housing and transmission.

FIG. 2 shows a schematic diagram of the center of mass for the shift lever of FIG. 1.

FIG. 3 shows a top view of an embodiment of the invention, including shift lever, pivot and counterbalance.

FIG. 3A shows an isolator of the embodiment of FIG. 3.

FIG. 3B shows a different view of the isolator of FIG. 3A.

FIG. 4 shows a side schematic view of the embodiment of FIG. 3 on a vehicle such as a truck.

FIG. 5 shows the movement of the center of mass by use of a counterbalance.

FIG. 6 shows an alternative embodiment of the invention wherein the shift lever is bent to form a counterbalance.

FIG. 7 illustrates another embodiment on the invention including shift lever, pivot and counterbalance.

FIG. 8 illustrates a side schematic view of the embodiment of FIG. 7 on a vehicle such as a truck.

FIG. 9 illustrates an overhead view of the embodiment of FIGS. 7 and 8.

### DETAILED DESCRIPTION OF THE PREFERRED EMBODIMENTS

Shift levers used in vehicles today fail to employ counterbalances. Generally, such a counterbalance is not required because the shift lever does not experience a sufficient amount of torque caused by vibrations from road conditions to jar the shift lever from its gear position. Consequently, only the torque from an operator's actuation of the shift lever causes a vehicle transmission to exit a gear.

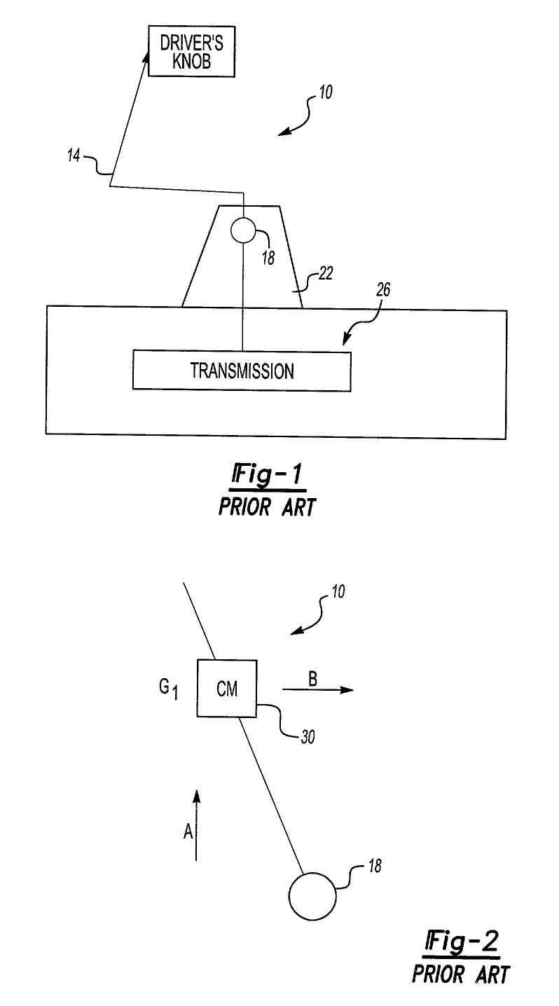

Designs of shift levers may employ bends or other configurations that may create undesired torque on the shift lever during vehicle operation. Shown in FIG. 1 is shift lever 10 with bend 14, pivot 18, and housing 22 to support shift lever 10 and pivot 18. Shift lever 10 may be connected and supported by housing 22 through pivot 18, a pivot point, as known. As can be seen, shift lever 10 is operatively connected to transmission 26. FIG. 2 illustrates schematically the center of mass of shift lever 10 distant from pivot 18 at location G₁. Center of mass 30 experiences force from road vibration in the direction of arrow A. Consequently, force in the direction of arrow B is created resulting in rotation of shift lever 10 about pivot 18. This force in the direction of arrow B creates a torque on shift lever 10, creating a tendency for shift lever 10 to disengage the gears of transmission 26 and also increasing the difficulty of shifting of the shift lever from one position to another.

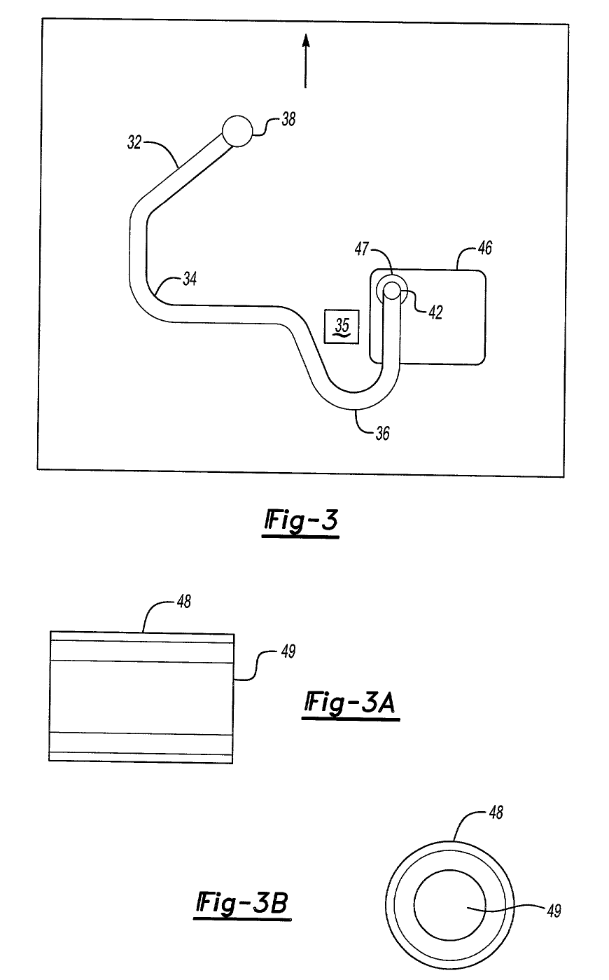

An embodiment of the present invention is seen in FIG. 3. Shift lever 32 has driver's knob 38, bend 34, bend 36 and pivot 42. Shift lever 32 may operatively connect to pivot 47 through isolator 47 as known to isolate vibration from road to limit shaking of driver's knob 38. As shown, bend 36 may be formed to position the knob proximate to operator due to location of transmission relative to cab components. In contrast to the prior art, shift lever 32 also has counterbalance 46. Counterbalance 46 comprises a second center of mass of sufficient size and location with respect to pivot 42 such that the total center of mass of shift lever 32 and counterbalance 46 is located closer to pivot 42. In this way, the location of the center of mass may be adjusted to avoid shift lever disengagement caused by vehicle conditions such as vibrations from road conditions. Counterbalance 46 may be such that it permits the predetermined resistance of a retaining component such as a detent to retain shift lever in its position. That is, the predetermined resistance level maintains shift lever 32 in the desired gear position because the moment generated by road conditions is less than this predetermined resistance level. The moment is kept beneath this level by the movement of the total center of mass closer to pivot 42. Moreover, moving the center of mass closer to pivot 42 also improves the shiftability of shift lever 32 so that shift lever 32 may be moved more easily from one gear position to another.

FIGS. 3A and 3B show isolator 47 of FIG. 3. Isolator 47 comprises a resilient sleeve formed into a cylinder that is inserted into counterbalance 46 as known. Cylinder hole 49 connects to pivot 42. Pivot 42 is resiliently connected to counterbalance 46 and shift lever 32. An isolator may be employed for any of the designs.

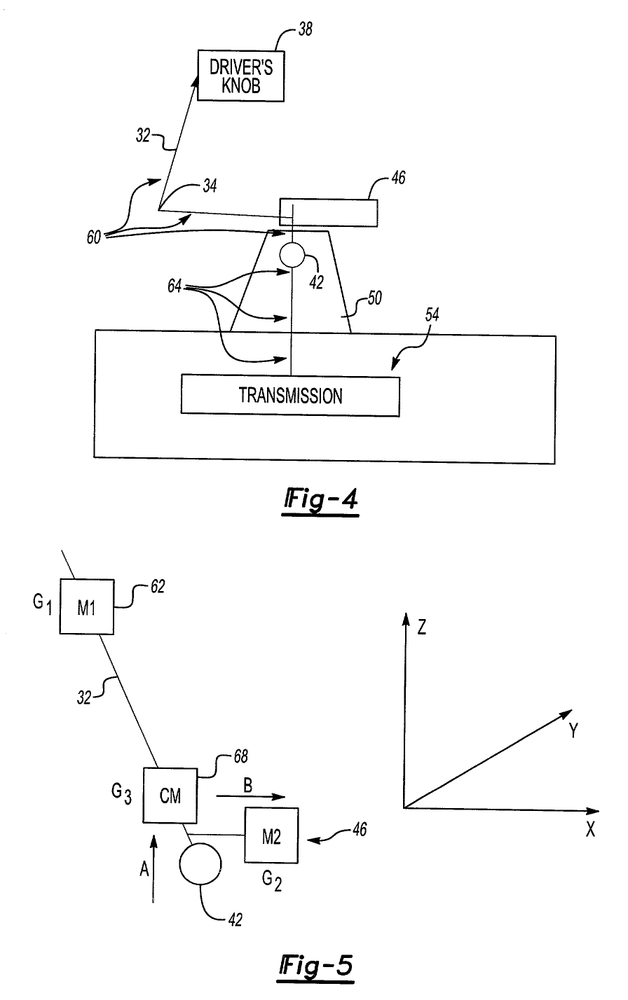

FIG. 4 illustrates a schematic side view of the design of FIG. 3, including shift lever 32 with bend 34 and driver's knob 38. Shift lever 32 comprises first portion 60 and second portion 64. Pivot 42 serves as the dividing location of shift lever 32 into first portion 60 and second portion 64. Pivot 42 is supported by shift housing 50. As shown, second portion 64 engages transmission 54 such that movement of shift lever 32 causes the transmission to change gears. Counterbalance 46 is attached to first portion 60 above pivot 42.

FIG. 5 illustrates the change in location of total center of mass as a consequence of counterbalance 46. Shift lever 32 comprises first center mass 62 that is distant from pivot 42 located at first location G₁. Without counterbalance 46, first center of mass 62 would be the total center of mass of shift lever 32 and would be at location G₁. However, the addition of counterbalance 46 at location G₂ moves total center of mass 68 to location G₃, closer to pivot 42 along the x-axis and z-axis as shown. The x-axis is perpendicular to the z-axis, which are both perpendicular to the y-axis. The x-axis and the y-axis define a horizontal plane while the z-axis comprises a vertical axis, extending from the plane. As a consequence of the location of total center of mass 68 between G₁ and G₂, force in the direction of arrow A results in less torque in the direction of arrow B. In this way, the possibility of shift lever 32 disengaging transmission 54 is greatly diminished. Also, the shifting is made easier for an operator.

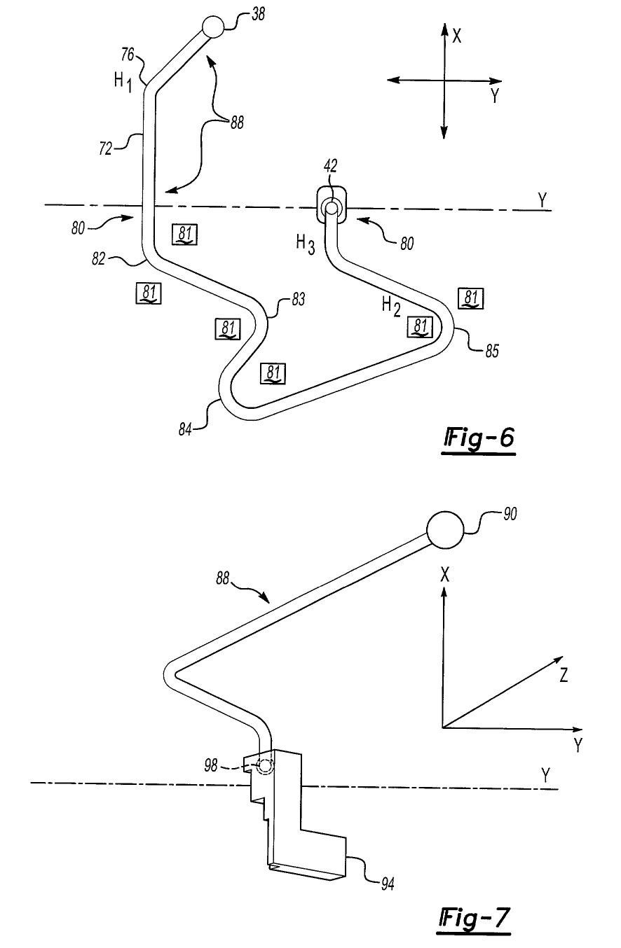

FIG. 6 illustrates another feature of the invention. Shown from an overhead view are shift lever 72 with driver's knob 38, bend 76, and pivot 42. Bend 76 extends vertically from the x-y plane. Shift lever 72 pivots along the y-axis. Here, shift lever 72 comprises first portion 88 and second portion 80. First portion 88 extends on one side of the y-axis while second portion 80 extends on the other side as shown. First portion 88 of shift lever 72 comprises drivers shift knob 38 and bend 76. Second portion 80 comprises multiple bends 82, 83, 84 and 85. Bends 82, 83, 84 and 85 may serve to wrap second portion of shift lever 80 around transmission components 81 to direct and connect second portion 80 to pivot 42. Bend 82 may comprise an elbow shape turn facing one direction while bend 83 comprises an elbow shape turn facing the opposite direction. Bends 84 and 85 may comprise elbow shape turns facing each other.

In addition, bends 82, 83, 84 and 85 may serve as a counterbalance for first portion 88. Thus, while first portion 88 may have a center of mass at location H₁ and second portion 80 may have a center of mass at location H₂ bends 82, 83, 84 and 85 of second portion 80 serve to offset mass of first portion 88 to produce a total center of mass at H₃, between locations H₂ and H₁, and closer to pivot 42, again reducing likelihood of jump out and improving shift lever balance.

Accordingly, the center of mass of shift lever 72 is adjusted and portions of shift lever 72 are bent so as to move the center of mass closer to pivot 42. Bends 82, 83, 84 and 85 may achieve this objective while still avoiding interference with transmission components 81. Shift lever 72 is connected to pivot and then transmission as known. Bends may move the center of mass along a vertical and a horizontal axis closer to pivot 42.

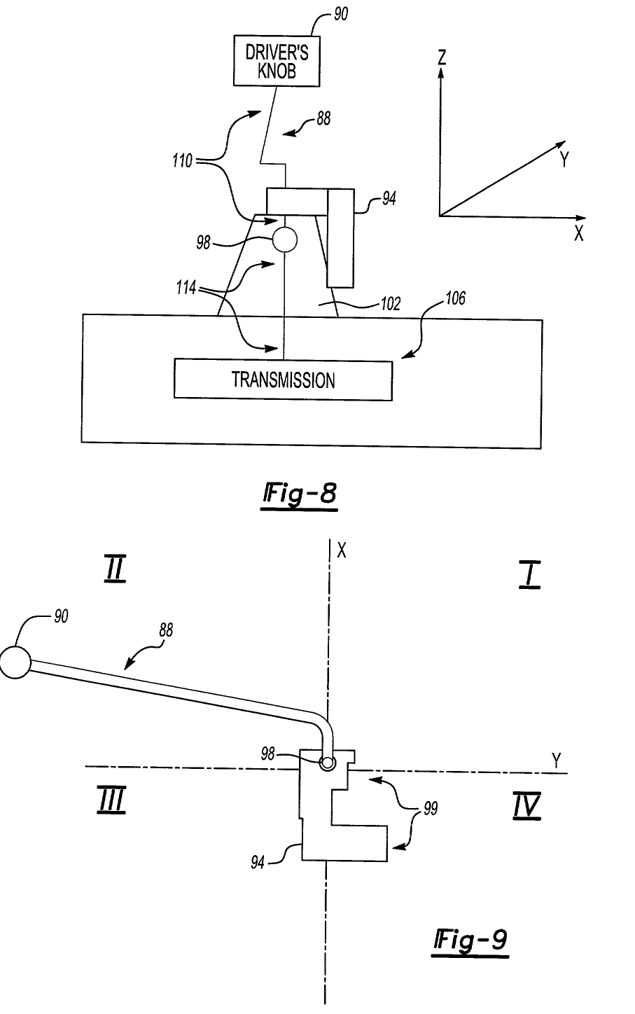

FIGS. 7, 8 and 9 illustrate a third feature of the invention. This embodiment has shift lever 88, pivot 98, counterbalance 94 and driver's knob 90. As can be appreciated in FIG. 8, a schematic side view of the embodiment of FIG. 7, counterbalance 94 adjust mass of shift lever 88 over pivot 98 along the x-axis, y-axis and z-axis. Counterbalance 94 is mounted to first arm 110 outside of housing 102. Second arm 114 of shift lever 88 engages transmission 106. Extending counterbalance 94 across pivot 98 permits better balancing of shift lever 88 to thereby move the center of mass of shift lever 88 closer to pivot 98.

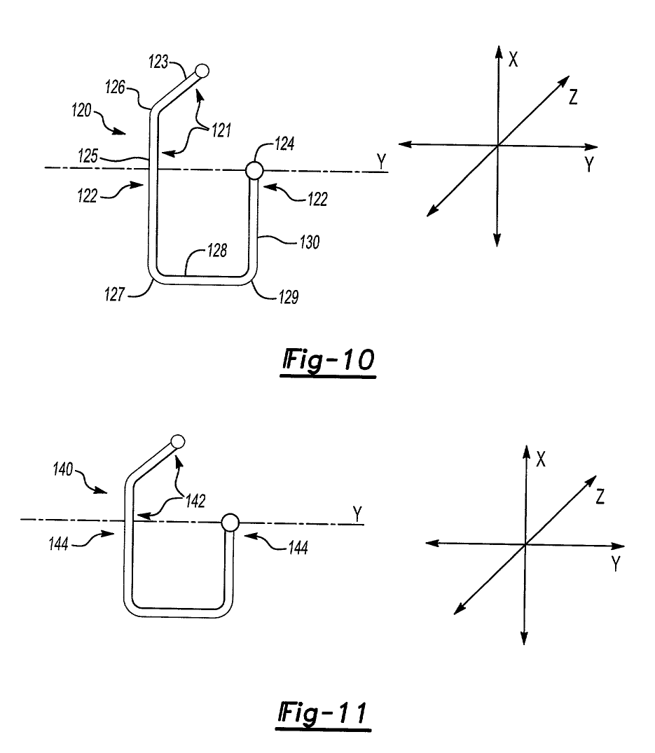

Specifically, as seen in FIG. 9, shift lever 88 comprises first portion 88 extending into the second quadrant and second portion 99 extending into the fourth quadrant. Second portion 99 comprises a mass extending along both the x-axis and y-axis into the fourth quadrant. The extension of this mass offsets the mass of first portion 89 to move total center of mass of shift lever 88 to its pivot 98. Thus, shift lever 88 is balanced along two different directions (axises).

Moreover, as shown in FIG. 8, counterbalance 94 may also serve to balance shift lever 88 vertically along the z-axis. First arm 110 extending above pivot 98 may have its mass offset by counterbalance 94, which extends below pivot 98. Accordingly, the total center of mass is adjusted vertically.

FIGS. 10 and 11 illustrate two other features of the invention. FIG. 10 shows shift lever 120 while FIG. 11 shows shift lever 140. Shift lever 120 comprises first portion 121, second portion 122. First portion 121 extends on one side of pivot 124 while second portion 121 extends over other side of pivot 124 to counterbalance first portion 120. First portion 121 comprises vertical arm 123 extending along z-axis and horizontal arm 125 extending along the x-axis. Vertical arm 123 is joined at bend 126 to horizontal arm 125. Second portion 121 comprises horizontal arm 126 extending along x-axis to bend 127, which joins horizontal arm 128 extending along y-axis. Horizontal arm 128 joints bend 129, which joins horizontal arm 130 extending along the x-axis and connecting shift lever 120 to pivot 124.

FIG. 11 shows a feature similar to the feature of FIG. 10. Shift lever 140 comprises first portion 142, second portion 144. First portion 142 is shorter than first portion 121 of FIG. 10. Consequently, second portion 144 may also be shorter than second portion 122 of FIG. 10 to serve as a counterbalance.

Based on this disclosure, one of ordinary skill in the art may envision alternative embodiments not specifically described here. The technique involves a shift lever on a pivot with a counterbalance. The counterbalance serves to offset the mass of the shift lever so as to locate the center of mass of the shift lever closer to the pivot. The shift lever is then engaged to a transmission. The center mass may be adjusted in this way to avoid “jump out” of shift lever and premature exiting of the gear of the transmission. Moreover, the overall balancing of the shift lever improves greatly the shiftability of the lever from one gear position to another.

The aforementioned description is exemplary rather than limiting. Many modifications and variations on the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise then as specifically described. For this reason, the following claims should be studied to terminate the true scope and content of this invention.

What is claimed is:

1. A transmission assembly comprising;
a transmission having a member movable about a pivot between a plurality of gear positions;
a shift lever operatively connected to said pivot for manipulating said member, said shift lever having a first center of mass at a first location relative to said pivot; and
a counterbalance operatively connected to said shift lever and having a second center of mass at a second location relative to said pivot different than said first location, producing a total center of mass for said shift lever located between said first location and said second location.

2. The transmission assembly of claim 1 wherein said first location comprises a first horizontal location and a first vertical location and said second location comprises a second horizontal location and a second vertical location wherein said total center of mass is located between said first horizontal location and said second horizontal location.

3. The transmission assembly of claim 2 wherein said total center of mass is horizontally located closer to said pivot than said first horizontal location.

4. The transmission assembly of claim 1 wherein said first location comprises a first horizontal location and a first vertical location and said second location comprises a second horizontal location and a second vertical location wherein said total center of mass is located between said first vertical location and said second vertical location.

5. The transmission assembly of claim 4 wherein said total center of mass is vertically located closer to said pivot than said first vertical location.

6. The transmission assembly of claim 1 wherein said first location comprises a first horizontal location and a first vertical location and said second location comprises a second horizontal location and a second vertical location wherein said total center of mass is located between said first vertical location and said second vertical location and between said first horizontal location and said second horizontal location.

7. The transmission assembly of claim 1 wherein said counterbalance comprises an isolator including a counterbalance mass and a resilient connection between said counterbalance mass and said shift lever reducing vibration of said shift lever during vehicle operation.

8. The transmission assembly of claim 1 including a housing supporting said pivot wherein said counterbalance is located at least partially outside of said housing.

9. The transmission assembly of claim 1 including a housing supporting said pivot wherein said pivot is located at least partially inside of said housing.

10. The transmission assembly of claim 1 wherein said first center of mass generates a first moment urging said member in a first direction out of one of said gear positions and said second center of mass generates a second moment in a second direction opposite said first direction to maintain said member in a desired gear position.

11. The transmission assembly of claim 10 wherein a predetermined resistance level maintains said member in said desired gear position and said first moment is greater than said predetermined resistance level and the sum of said first and second moment is less than said predetermined resistance level.

12. A transmission assembly comprising;
a transmission having a member movable about a pivot between a plurality of gear positions; and
a shift lever operatively connected to said pivot for manipulating said member, said shift lever having an unbent state with a first center of mass at a first location relative to said pivot, and shift lever having a bent state with at least one bend having a second center of mass at a second location relative to said pivot different than said first location, producing a total center of mass for said shift lever located between said first location and said second location wherein said first center of mass generates a first moment urging said member in a first direction out of one of said gear positions and said second center of mass generates a second moment in a second direction generally opposite said first direction to maintain said member in a desired gear position and the sum of said first moment and said second moment is less than said predetermined resistance level.

13. The transmission assembly of claim 12 wherein said shift lever comprises a first horizontal portion extending on one side of said pivot and a second horizontal portion extending on the other side of said pivot wherein said second portion comprises said at least one bend.

14. The transmission assembly of claim 13 wherein said at least one bend comprises a plurality of bends.

15. A method of manufacturing a shift lever comprising the steps of:
a) determining a location of a center of mass of a shift lever relative to a pivot;
b) determining a desired location of the center of mass;
c) providing a bend on at least one portion of the shift lever to move the center of mass to the desired location; and
d) moving the location of the center of mass closer to the pivot.

16. The method of manufacturing the shift lever of claim 15 wherein step b) comprises a plurality of bends in the shift lever.

17. The method of manufacturing the shift lever of claim 15 including the step of providing a bend on a shift lever around a transmission component.

18. The method of manufacturing the shift lever of claim 15 including the step of operatively connecting the shift lever to a transmission.

19. The method of manufacturing the shift lever of claim 15 wherein moving the location of the center of mass is vertical.

20. The method of manufacturing the shift lever of claim 19 wherein moving the location of the c enter of mass is horizontal.
